(19) United States
(12) Patent Application Publication
(10) Pub. No.: US 2021/0351708 A1
(43) Pub. Date: Nov. 11, 2021

(54) METHOD FOR CONTROLLING A SERIES RESONANT CONVERTER

(71) Applicant: Karlsruher Institut für Technologie, Karlsruhe (DE)

(72) Inventors: Michael Heidinger, Karlsruhe (DE); Wolfgang Heering, Stutensee (DE); Rainer Kling, Dossenheim (DE)

(73) Assignee: Karlsruher Institut für Technologie, Karlsruhe (DE)

(21) Appl. No.: 17/250,894

(22) PCT Filed: Sep. 27, 2019
(86) PCT No.: PCT/EP2019/076231

§ 371 Date: Mar. 22, 2021

(30) Foreign Application Priority Data
Sep. 28, 2018 (DE) 10 2018 216 749.4

(51) Int. Cl. H02M 3/335; H02M 1/42; H02M 1/00

(52) U.S. Cl. CPC H02M 3/33571; H02M 3/33573; H02M 1/0058; H02M 1/4241

(57) ABSTRACT

The invention relates to a method for controlling a series resonant converter (110), wherein the series resonant converter (110) comprises a primary circuit (112) and a secondary circuit (114), wherein the primary circuit (112) or the secondary circuit (114) comprises a series resonant oscillating circuit (118), wherein the series resonant oscillating circuit (118) comprises at least one capacitance C₁ and at least one inductance Lᵢ, wherein a link voltage U_{dc} is applied to the primary circuit (112), and wherein the secondary circuit (114) provides an average output current Īₒᵤₜ, wherein the control of the series resonant converter (110) is carried out by adjusting an averaged value of the output current Īₒᵤₜ using a transfer function, wherein the transfer function is a function of the link voltage U_{dc}, the output voltage U_{Cout}, the inductance Lᵢ, a switching period tₚ and a duty cycle D, wherein at least the switching period tₚ and/or the duty cycle D are adjusted.

The invention furthermore relates to a computer program which is configured to carry out the method at least partially.

### FIELD OF THE INVENTION

The present invention belongs to the field of electrical engineering, and relates to a method for controlling a series resonant converter and to a computer program which is configured to carry out steps of this method.

### PRIOR ART

Various methods for operating a series resonant converter (SRC) are known from the prior art. The series resonant converter is one of the DC-DC converters which comprise a series resonant oscillating circuit, a DC (direct current) voltage being converted into an AC (alternating current) voltage, which is subsequently rectified.

The series resonant converter with DC isolation comprises a half bridge or a full bridge which drives the series resonant oscillating circuit with a unipolar or bipolar square-wave voltage. The series resonant oscillating circuit is usually part of a primary circuit which is connected to a primary side of a transformer. As an alternative, the series resonant oscillating circuit may also be accommodated in a secondary circuit which is connected to a secondary side of the transformer. On the secondary side of the transformer, there is a rectifier network which converts the generated AC voltage back into a DC voltage. The series resonant converter without DC isolation likewise comprises in a primary circuit a half bridge or a full bridge which is connected to the series resonant oscillating circuit, the output voltage of which is rectified by using a bridge rectifier located in the secondary circuit.

A DC link voltage U_{dc} is applied in the primary circuit, while an output voltage U_{Cout} and an output current Iₒᵤₜ can be tapped at the secondary circuit. In this case, the primary circuit may be configured as a half bridge and have a configuration with two switches, which may be used to apply the link voltage U_{dc} to a switch node SW or to connect the switch nodes SW to a zero potential. The term “switching point” may also be used instead of the term “switch node”. As an alternative, the primary circuit may comprise a full bridge and have 4 switches. A period within which the switches are actuated in alternation is referred to as a “switching period”, and the associated inverse as a “switching frequency”.

A disadvantage of the known methods for operating a series resonant converter is regulation of the converter by using a regulating circuit or a regulating loop, for which only the instantaneous output voltage U_{Cout} is used. To this end, conventionally, the instantaneous output voltage U_{Cout} is measured and a predetermined setpoint value is thereby tracked. Conventionally, the control is carried out by using a switching frequency, although adaptations by using a duty cycle are also known. When using a full bridge, the phase may also be used for this. Particularly in order to average and buffer perturbing quantities as a function of time and thereby to achieve a sufficient quality of the regulation, large storage capacitors are used in the primary circuit and in the secondary circuit. Such storage capacitors require large space, electrolytic capacitors whose lifetime is limited often being used. Furthermore, the series resonant converters are usually described as voltage-to-voltage converters, which may have an unfavorable regulating behavior, which may in particular be manifested by an overshoot.

Vorpérian, V. and Cuk, S., A complete DC analysis of the series resonant converter, in: 1982 IEEE Power Electronics Specialists conference, 1982, p. 85-100, describe the behavior as a function of time of the individual currents of the series resonant converter by using a time domain analysis. To this end a complex, not analytically soluble function is proposed, which models the series resonant converter as a voltage-to-voltage converter.

Mounika, D. and Porpandiselvi, S.: ADC Controlled Half-Bridge LC Series Resonant Converter for LED Lighting, in: 2^{nd} International Conference on Communication and Electronics Systems, ICCES, 2017, p. 1037-1042, describe a driving method for LED applications. This method relates to a half-bridge series resonant converter, an output of the converter being used to drive an LED. In this case, an asymmetrical duty cycle is used.

A. Polleri, Taufik and M. Anwari, Modeling and Simulation of Paralleled Series-Loaded-Resonant Converter, Second Asia International Conference on Modelling & Simulation 2008, IEEE Computer Society, p. 974-979, describe modelling of a series resonant converter which is equipped with a plurality of resonant circuits and is used in a current supply for high voltages and high frequencies for medical applications.

DE 102015121991 A1 discloses a method which uses an additional duty cycle adjustment in a series resonant converter, particularly when starting up and/or for current limitation in the event of an output short circuit.

Further methods for controlling a series resonant converter are disclosed in DE 10143251 A1 and US 2012/0262954 A1.

### OBJECT OF THE INVENTION

Basis hereon, the object of the present invention is to provide a method for controlling a series resonant converter and a computer program which is configured to carry out steps of this method, which at least partially overcome the known disadvantages and restrictions of the prior art.

The method for controlling the series resonant converter is intended, in particular, to allow operation of the series resonant converter by using a linearizing feedforward control. In this way, the intention is to make it possible to be able to use smaller capacitors in order to be able to replace the hitherto used electrolytic capacitors, so as to thus increase the lifetime of the switched-mode power supply.

### DISCLOSURE OF THE INVENTION

This object is achieved by a method for controlling a series resonant converter and a computer program which is configured to carry out steps of this method, according to the features of the independent claims. Advantageous refinements, which may be implemented individually or in any desired combination, are presented in the dependent claims.

In what follows, the terms “have”, “contain”, “comprise” or “include” or any grammatical variants thereof are used not exclusively. Correspondingly, these terms may relate both to situations in which no further features are present besides the features introduced by these terms, or to situations in which one or more further features are present. For example, the expression “A has B”, “A contains B”, “A comprises B” or “A includes B” may relate both to situations in which there is no further element apart from B in A (i.e. to situations in which A consists exclusively of B) and to situations in which there are one or more further elements, for example element C, elements C and D or even further elements, in addition to B, in A.

Furthermore, it is to be pointed out that the terms “at least one” and “one or more” as well as grammatical variants of these terms when they are used in connection with one or more elements or features and are intended to mean that the element or feature may be provided in the singular or plural, are generally used only once, for example when introducing the feature or element for the first time. When subsequently mentioning the feature or element again, the corresponding term “at least one” or “one or more” is generally no longer used, unless this restricts the possibility that the feature or element may be provided in the singular or in the plural.

Furthermore in what follows the terms “preferably”, “in particular”, “for example” or similar terms are used in connection with optional features without alternative embodiments thereby being restricted. Thus, features which are introduced by these terms are optional features, and the protective scope of the claims, and in particular of the independent claims, is not intended to be restricted by these features. Thus, as the person skilled in the art will realize, the invention may also be carried out by using other configurations. Similarly, features which are introduced by “in one embodiment of the invention” or by “in one exemplary embodiment of the invention” are to be understood as optional features, without alternative configurations or the protective scope of the independent claims being intended to be restricted by this. Furthermore, all possibilities of combining the features thereby introduced with other features, whether optional or non-optional features, are intended to remain unaffected by these introductory expressions.

In a first aspect, the present invention relates to a method for controlling a series resonant converter (SRC). The term “series resonant converter” in this case denotes a circuit topology for an electrical switched-mode power supply which is configured to convert a DC voltage applied to a primary circuit, which is also referred to as a DC link voltage U_{dc}, into a DC voltage applied to an output of a secondary circuit, which is also referred to as an output voltage U_{Cout}, in which case the primary circuit and the secondary circuit may be DC-isolated from one another. As described in the introduction, however, series resonant converters may also be provided without DC isolation. DC isolation may preferably be carried out by using a transformer, although other types of potential isolation are also possible. In this case, an electrical voltage which does not change its sign over a time interval is referred to as a “DC voltage”. Conversely, an electrical voltage whose sign changes within a time interval in regular repetition is referred to as an “AC voltage”. A “unipolar square-wave voltage” is intended to mean a voltage which changes between a positive value and zero potential within a time interval. “DC isolation” is in this case intended to mean that there is no electrical conduction between the primary circuit and the secondary circuit, so that the two potentials are isolated from one another. In the case of the series resonant converter, the DC isolation may preferably be carried out by using a transformer which allows exchange of an electrical power between the primary circuit and the secondary circuit by using inductive coupling. Other possibilities for the DC isolation are, however, also possible.

As mentioned in more detail below, the “series resonant converter” in this case comprises an oscillating circuit, which is arranged in the primary circuit and connected in series with a rectifier network present in the secondary circuit. The oscillating circuit arranged in the primary circuit has at least one capacitance C₁ and at least one inductance Lᵢ, which are connected in series and which may be in the form of a capacitor and a coil, and furthermore a switch configuration comprising two switches S₁, S₂. To this end, respectively only one of the two switches may be set to “ON” during a determined time period, while the other of the two switches is set to “OFF” during the same time period. By this switch configuration, which is also referred to as a “half bridge”, it is possible to generate a unipolar square-wave voltage that can be adjusted freely in frequency and duty cycle between the link voltage U_{dc} and a zero potential at a switch node (SW). In an alternative configuration, it is possible to use another method, in particular an amplifier, for generating the unipolar square-wave voltage in the half bridge. By using the half bridge or the amplifier, an AC voltage having a DC voltage component may be generated here. The capacitance C₁ may in this case be used to suppress a DC component of a previous AC voltage. The remaining AC voltage may be transferred by inductive coupling by using the transformer from the primary circuit into the secondary circuit. In one particular configuration, a further circuit, in particular a circuit for power factor correction (PFC) may be added at the switch node SW.

The time period within which initially a first switch S₁ is respectively set to “ON” and a second switch S₂ is subsequently set to “ON” is referred to as a “switching period” tₚ, and the associated inverse as a “switching frequency” fₚ=1/tₚ. In the case of the series resonant converter, a switching voltage U_{SW}>0 may be applied during a first time period in which the first switch S₁ is set to “ON”, while the switching voltage may be U_{SW}=0 during a second time period in which the second switch S₂ is set to “ON”. In this case, a “duty cycle” D may be specified, which is defined in that the time D·tₚ indicates a time interval during which the switching voltage is U_{SW}=0. As an alternative, the duty cycle may also be referred to as a “duty factor”. A duty cycle D=0.5 in this case means that the first switch S₁ is set to “ON” for exactly as long as the second switch S₂, so that within each switching period tₚ a switching voltage U_{SW}>0 is applied for exactly as long as the switching voltage is U_{SW}, =0. With other duty cycles D, there are correspondingly different values.

According to the invention—in contrast to the prior art, which uses regulation of the series resonant converter on the basis of the instantaneous output voltage U_{Cout}—the operation of the series resonant converter is carried out by using a method for controlling the series resonant converter. While the term “regulation” denotes a mode of operation in which the instantaneous output voltage U_{Cout} is measured and a deviation from a predetermined setpoint value is determined in order to reduce the deviation by using a regulating circuit or a regulating loop, a measured quantity being used as an input quantity for the regulating circuit or the regulating loop, in the mode of operation referred to as “control” at least one output quantity is obtained directly by at least one input quantity being entered into a known relationship such that the desired output quantity can be determined directly therefrom. The known relationship may in this case also be referred to as a “transfer function”. Furthermore, in the prior art the duty cycle or the switching frequency are specified without considering any perturbing quantities such as the input voltage. As explained in the introduction, the use of a series resonant converter as a voltage-to-voltage converter is furthermore known from the prior art. The proposed regulating method describes the series resonant converter as a voltage-to-voltage converter, so that faster and more robust regulation is made possible. Furthermore—in contrast to the prior art—perturbing quantity consideration is carried out here, which also includes the effect of any perturbing quantities, for example a varying input voltage.

According to the invention, it is proposed to carry out the control of the series resonant converter by adjusting an averaged value of the output current Īₒᵤₜ by using a transfer function, the transfer function being a function of the link voltage U_{dc}, the output voltage U_{Cout}, the switching period tₚ, the duty cycle D, and optionally the capacitance C₁, wherein the switching period tₚ or the duty cycle D or both the switching period tₚ and the duty cycle D are adjusted. The term “adjust” in relation to the quantities of switching period tₚ and duty cycle D in this case refers to a possibility of selecting these quantities freely, particularly in wide limits, so as to thus be able to obtain as many values as possible of the averaged value of the output current Īₒᵤₜ, which is used as the output quantity. The two quantities of switching period tₚ and duty cycle D may, as explained in more detail above and below, both be adjusted in a very simple way and independently of one another and each freely selected over a large range, and therefore used as degrees of freedom, by actuating the switches S₁, S₂ provided in the primary circuit. For example, with a constant switching period tₚ, only the duty cycle D may be varied. As an alternative, with a constant duty cycle D, only the switching period tₚ, may be varied. Combinations thereof are likewise possible. In the configuration in which a circuit for power factor correction is added at the switch node SW, both the switching period tₚ and the duty cycle D may be used as two degrees of freedom, for example. The method proposed here therefore has a substantial advantage in the operation of the series resonant converter. In this case, the series resonant converter may be optimized in particular in respect of a minimal output voltage ripple, i.e. a minimal variation in the output voltage U_{Cout}, or a minimal power loss, i.e. minimal losses during the operation of the series resonant converter. Other types of optimization, for instance in respect of smaller output capacitors, are however likewise possible.

In a preferred embodiment, a value of from 0.1 to 0.9, particularly preferably from 0.2 to 0.8, in particular from 0.4 to 0.6, may be selected for the duty cycle D. As an alternative or in addition, a value of from 0.1 us to 100 ms, particularly preferably from 0.5 us to 5 ms, in particular from 1 us to 1 ms, may be selected for the switching period tₚ. Other values of the switching period tₚ and/or the duty cycle D are, however, possible.

In contrast hereto, the quantities of link voltage U_{dc}, capacitor voltage U_{C1} and output voltage U_{Cout} can in this case be regarded as fixed quantities of the transfer function and not as further adjustable input quantities, since they change only marginally during a switching period tₚ. This may be apposite since these two further quantities are usually subject to technical constraints and conditions which can be changed only with difficulty or scarcely at all, and therefore can be neither adjusted rapidly in a straightforward way nor freely selected rapidly over a large range. It is, however, advantageous for it to be possible to avoid using these two further quantities as adjustable input quantities, since the associated technical constraints may then substantially be ignored during the operation of the series resonant converter. In a further configuration, as an alternative or in addition, the inductance Lᵢ present in the oscillating circuit may also be varied; in practice, however, this may be more elaborate than the above-proposed variation of the quantities of switching period tₚ and duty cycle D.

Furthermore, the averaged value of the output current Īₒᵤₜ may be adjusted by applying the selected transfer function. It is therefore advantageously possible to freely select the average output current Īₒᵤₜ, which is applied to an output of the secondary circuit, in wide limits substantially independently of the associated output voltage U_{Cout} and the input voltage U_{dc}. Since, as is known, the output power Pₒᵤₜ, applied to the output of the secondary circuit, represents the product of the output voltage U_{Cout} and the average output current Īₒᵤₜ, in this way the output power Pₒᵤₜ may also particularly advantageously be both adjusted in a very straightforward way and freely selected over a large range.

As already mentioned, the primary circuit of the series resonant converter comprises an oscillating circuit which may have at least one capacitance C₁, particularly in the form of at least one capacitor, and at least one inductance Lᵢ, particularly in the form of at least one coil, which are connected in series. From the proposed arrangement of the capacitance C₁ and the inductance Lᵢ in series, in the known way it is possible to determine an associated resonant frequency f_{R} of the oscillating circuit. Conventionally, the instantaneous output current Iₒᵤₜ of the series resonant converter exhibits a sinusoidal profile. If operation of the series resonant converter is carried out in a preferred way at a frequency above the resonant frequency f_{R}, however, a first Taylor series approximation of the sinusoidal profile may be used so that a linear approximation may be obtained. In this case, the operation of the series resonant converter may be carried out at a frequency preferably above 1.5 times, particularly preferably 2 times (double) the resonant frequency f_{R}. A higher frequency for the operation of the series resonant converter is, however, possible and may be technically used.

In a particularly preferred embodiment of the present invention, the averaged value of the output current Īₒᵤₜ may be determined by using the following transfer function according to Equation (1)

$${\overline{I}}_{out} = \frac{D ( 1 - D ) {U}_{dc}^{2} - {U}_{Cout}^{2}}{4 {L}_{i} {U}_{dc}} \cdot {t}_{p} . \qquad ( 1 )$$

In a preferred embodiment, the inductance Lᵢ in Equation (1) may be regarded as constant. The other two quantities, namely the link voltage U_{dc} and the output voltage U_{Cout} may, as explained above, preferably likewise be regarded as fixed quantities. In contrast thereto, the two quantities of switching period tₚ and duty cycle D, as explained in more detail above and below, may be adjusted independently of one another in a very straightforward way and respectively selected freely over a large range by actuating the switches S₁, S₂ provided in the primary circuit.

Because of the linear relationship represented in Equation (1) between the output current Īₒᵤₜ and the switching period tₚ, the averaged output current Īₒᵤₜ may be established very simply by the selection of the switching period tₚ. As an alternative or in addition, Equation (1) may also be analytically solved for the duty cycle D, which is in a quadratic relationship with the output current Īₒᵤₜ, in particular by using a microprocessor which is configured to solve a quadratic relationship, for instance by using the known solution formula for quadratic equations. As an alternative or in addition, numerical solution methods, in particular the Euler method, may be used to solve the equation. Other embodiments may, however, be envisioned; in particular, a solution in which a second, additional value is set and both quantities of switching period tₚ and duty cycle D are therefore required may be envisioned.

In a particularly preferred embodiment of the present method, the following method steps, which are simply referred to as “steps” below, may be carried out within a single switching period tₚ, the order specified, beginning with step a), which is then followed by steps b), c) and d) as indicated, being preferred:
a) switching on a half bridge arranged in the primary circuit, so that a current Iᵢ through the inductance Lᵢ increases as a function of time until a zero crossing occurs for the current Iᵢ;
b) increasing the current Iᵢ further as a function of time until the half bridge arranged in the primary circuit is switched off;
c) decreasing the current Iᵢ as a function of time until a zero crossing occurs for the current Iᵢ; and
d) decreasing the current Iᵢ further as a function of time.

According to step a), the half bridge which is located in the primary circuit is switched on, in particular by actuating the first switch S₁, which is set to “ON”, so that a switching voltage U_{SW}>0 can be applied, while the second switch S₂ remains set to “OFF”. A current Iᵢ through the inductance Lᵢ can therefore increase during a first time interval Δt₁ until a zero crossing can be observed for the current Iᵢ. As already mentioned above, the term “half bridge” in this case refers to a configuration which comprises two switches in series, the link voltage U_{dc} being applied as a supply voltage to the switch node SW by using the first switch S₁ as long as it is set to “ON”, and a zero potential being applied to the switch node SW by using the second switch S₂ as long as it is set to “ON”, only one of the two switches S₁, S₂ being switched on at a time. In an alternative albeit technically less advantageous embodiment, the half bridge may also be in the form of another configuration, particularly in the form of an amplifier. The term “full bridge” in this case refers to two half bridges which are both connected to the link voltage U_{dc} as a supply voltage, and the series resonant oscillating circuit of which lies between the midpoints of the half bridges. The term “zero crossing” in this case refers to an instant t₀ at which the current is Iᵢ=0, the current being Iᵢ<0 immediately before the instant t₀ and the current being Iᵢ>0 immediately after the instant t₀, or the current being Iᵢ>0 immediately before the instant t₀ and the current being Iᵢ<0 immediately after the instant t₀.

According to step b), during a second time interval Δt₂ a further increase of the current Iᵢ through the inductance Lᵢ takes place while the half bridge remains switched on, in particular by the first switch S₁ remaining set to “ON”, so that the switching voltage U_{SW}>0 can be applied as before. The second time interval Δt₂ ends when the half bridge arranged in the primary circuit is switched off. This may in particular be done by a further actuation of the first switch S₁, which is set to “OFF”, so that the switching voltage U_{SW}=0 can be set. Step c) is therefore now carried out. In this case, the second switch S₂ is set to “ON” so that the switching voltage can be U_{SW}=0. In this case, a decrease of the current Iᵢ through the inductance Lᵢ takes place during a third time interval Δt₃, until a further zero crossing can be observed for the current Iᵢ.

According to step d), during a fourth time interval Δt₄ a further decrease of the current Iᵢ through the inductance Lᵢ takes place while the half bridge remains switched off, in particular by the second switch S₂ remaining set to “ON”, so that the switching voltage can be U_{SW}=0 as before. The fourth time interval Δt₄ ends when, in a further switching period tₚ, according to step a) the half bridge arranged in the primary circuit is switched on again. This may in particular be done by a further actuation of the first switch S₁, which is again set to “ON”, so that the switching voltage can again be set to U_{SW}>0.

The switching pattern of the half bridge in conjunction with the oscillating circuit may therefore generate the described time profiles of current and voltage. In this case, the switching period tₚ may begin during each of the specified time intervals, for example with step c), following which steps d), a) and b) are then carried out in the order specified. For further details relating to the steps a) to d) described here, reference is made to the exemplary embodiments below.

In a particular embodiment, in addition to the control proposed here for the series resonant converter, regulation of the series resonant converter may also be carried out. To this end, in particular, a regulating circuit or a regulating loop may also be introduced into the circuit. In this way, the speed, accuracy and the stability of the series resonant converter may be increased further. In the control proposed here for the series resonant converter, both the link voltage U_{dc} and the output voltage U_{Cout} are known. Because a control circuit or a control loop is robust in respect of variations of the link voltage U_{dc}, since this is already included in the analytically soluble transfer function, the at least one capacitor in the primary circuit may be selected to be much smaller.

In a further aspect, the present invention relates to a computer program which is configured to carry out steps of the method described herein for controlling a series resonant converter.

To this end, the computer program may comprise algorithms which are particularly configured to carry out individual or several method steps or a part thereof. The computer program may in this case, in particular, be configured to control a microprocessor or a microcontroller, which may interact with the series resonant converter, for example by controlling the switches S₁, S₂, so that the switching period tₚ and the duty cycle D can be adjusted very simply. To this end, a conventional integrated unit for pulse width modulation (PWM) may preferably be used. As an alternative or in addition, the microprocessor may be used to adjust or read out the link voltage U_{dc}, the output voltage U_{Cout}, the output current Īₒᵤₜ or further electrical quantities in the series resonant converter. In an alternative embodiment, there may be an implementation of the computer program for carrying out the present method in at least one application-specific integrated circuit (ASIC) in a universal circuit, particularly in an FPGA (field-programmable gate array) or as an FPAA (field-programmable analog array). Further ways of carrying out the computer program are, however, possible. For further details relating to the configuration of the computer program, reference is made to the rest of the description and to the exemplary embodiments.

### Advantages of the Invention

The present invention for controlling a series resonant converter has a range of advantages over methods known from the prior art for operating a series resonant converter. The method described herein makes it possible to control an averaged value of the output current Īₒᵤₜ of a series resonant converter by using the switching frequency fₚ and/or by using the duty cycle D, and with a high accuracy which is robust in respect of perturbing quantities, for example the link voltage. The transfer function is furthermore analytically soluble when the switching frequency fₚ and/or the duty cycle D are known. In this case, it is possible to determine the switching frequency fₚ and/or the duty cycle D in order to obtain a desired averaged value of the output current Īₒᵤₜ. By adjusting the duty cycle D, for example, it is possible to determine the switching frequency fₚ in order to obtain the desired averaged value of the output current Īₒᵤₜ. Preferably, an analytical method may be used here; as an alternative or in addition, however, it is possible to use a numerical method. By a transfer function which is sufficiently accurate, it is therefore possible to carry out control of the series resonant converter for which a regulating circuit or a regulating loop may be obviated. In this case, the transfer function may be solved for the duty cycle D or for the switching frequency fₚ. As an alternative or in addition, however, it is possible to solve the transfer function by using a numerical method, equations that are not analytically soluble then being solved, although a higher computing power is needed for this. In order to further increase the accuracy and improve the dynamics and stability of the series resonant converter, however, a regulating circuit or a regulating loop may be used.

### BRIEF DESCRIPTION OF THE FIGURES

Further details and features of the present invention may be found in the following description of preferred exemplary embodiments, particularly in combination with the dependent claims. In this case, the respective features may be implemented separately, or several may be implemented in combination. The invention is not, however, restricted to the exemplary embodiments. The exemplary embodiments are represented schematically in the appended figures. In this case, references which are the same in the figures denote elements which are the same or functionally equivalent, or elements which correspond to one another in their functions. In detail:

FIG. 1 shows schematic representations of preferred embodiments of a series resonant converter;

FIG. 2 shows a schematic representation of a time profile of selected voltages and currents in a preferred embodiment of a method for controlling the series resonant converter;

FIG. 3 shows a representation of measurement results for the averaged value of an output current Īₒᵤₜ as a function of the output voltage Uₒᵤₜ of the primary side (FIG. 3a) and of the link voltage U_{dc} (FIG. 3b);

FIG. 4 shows a representation of measurement results for the time profile of the link voltage U_{dc} and of the instantaneous output current Īₒᵤₜ;

FIG. 5 shows a schematic representation of a further preferred embodiment of the series resonant converter, supplemented with a circuit for power factor correction;

FIG. 6 shows a representation of a circuit which was used for the simulation of embodiments of the series resonant converter; and

FIG. 7 shows a representation of various curve profiles which were obtained in the simulation according to FIG. 6.

### DESCRIPTION OF THE EXEMPLARY EMBODIMENTS

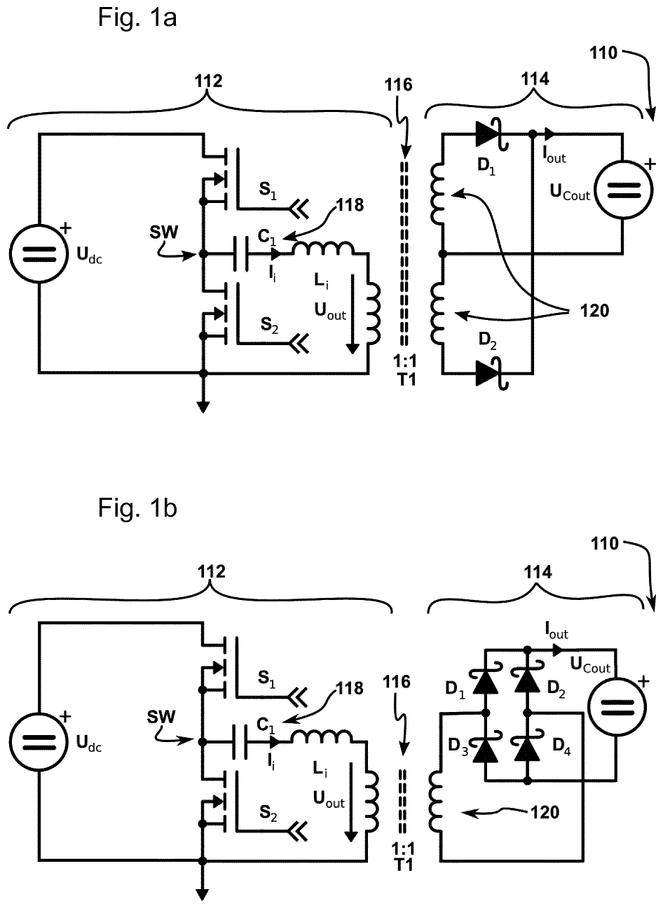

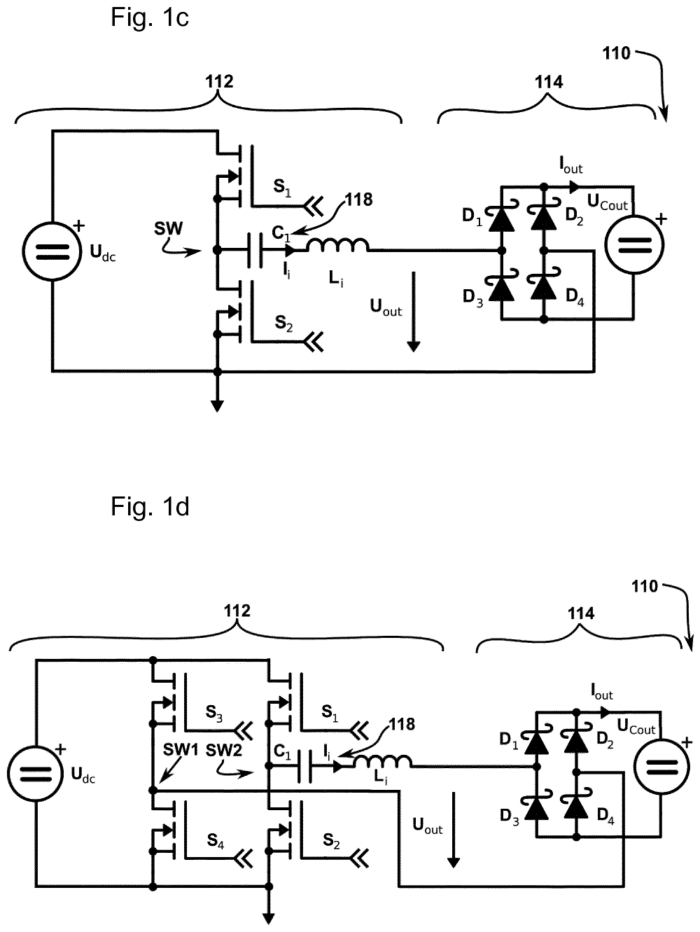

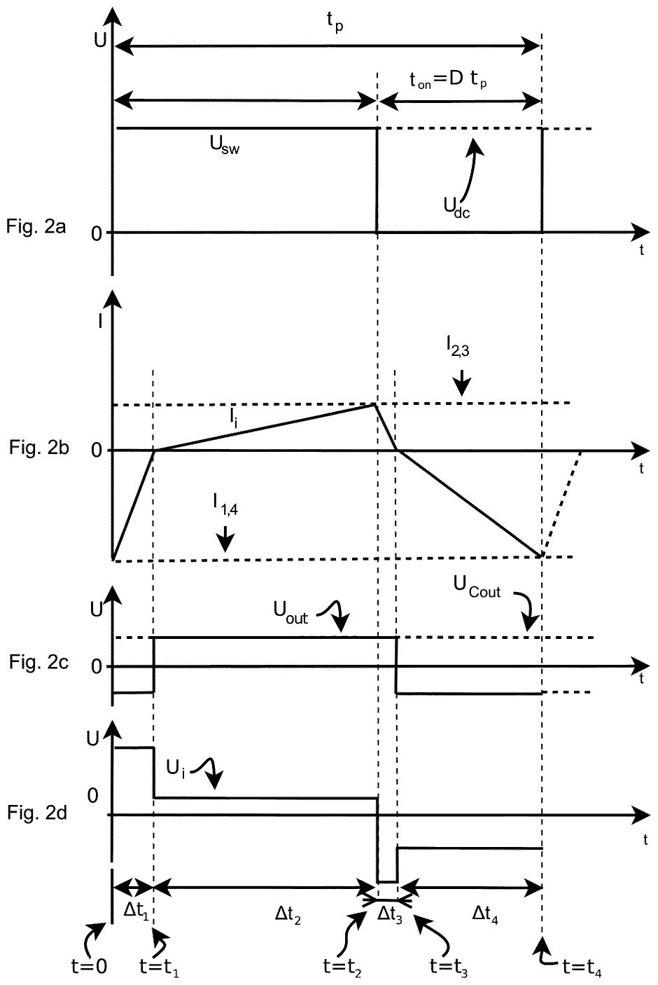

FIG. 1 shows schematic representations of preferred embodiments of a series resonant converter 110. Further embodiments are, however, possible. The series resonant converter 110 comprises a primary circuit 112 and a secondary circuit 114, the primary circuit 112 and the secondary circuit 114 being DC-isolated from one another by a transformer T1 116 in the embodiments according to FIGS. 1a and 1b. The use of the transformer 116 makes it possible to exchange electrical power between the primary circuit 112 and the secondary circuit 114 by using inductive coupling. In the representation of the series resonant converter 110 according to FIGS. 1a and 1b, the transformer 116 is configured as a 1:1 transformer; other types of embodiment of the transformer 116 are, however, possible. FIG. 1d shows an embodiment of the series resonant converter 110 in which a full bridge is used in the primary circuit 112, the full bridge in this case having a first switch node SW1 and a second switch node SW2. It is to be pointed out that the transformer 116 has an inherent magnetizing inductance due to its design. Since the magnetizing inductance has no effect on the output current Īₒᵤₜ, however, the magnetizing inductance has been neglected in order to simplify FIGS. 1 and 2.

A DC link voltage U_{dc}, which is usually provided as a DC voltage, is applied to the primary circuit 112. In order to generate an output voltage Uₒᵤₜ of the primary circuit 112 in the form of an AC voltage, the primary circuit 112 comprises a half bridge which is connected to a series resonant oscillating circuit 118 which, in the exemplary embodiments according to FIG. 1, comprises a capacitance C₁ in the form of a capacitor and an inductance Lᵢ in the form of a coil, which are connected in series. In this case, a current Iᵢ flows through the capacitance C₁. Other embodiments of the oscillating circuit may, however, be envisioned. From this arrangement of the capacitance C₁ and the inductance Lᵢ in series, it is possible to determine an associated resonant frequency f_{R} of the oscillating circuit, which may be described by the following Equation (2):

$${f}_{R} = \frac{1}{2 π \sqrt{{L}_{i} {C}_{1}}} . \qquad ( 2 )$$

As already mentioned, the primary circuit 112 may have a half bridge which preferably comprises two switches S₁, S₂ that may be used to generate a unipolar square-wave voltage at a switch node (SW). To this end, during a determined time period, only one of the two switches may respectively be set to “ON”, while the other of the two switches is set to “OFF” during the same time period. The two switches S₁, S₂ may, as schematically represented in the exemplary embodiments according to FIG. 1, in this case be configured as a metal-oxide-semiconductor field-effect transistor (MOSFET); other types of embodiment are, however, possible.

Particularly in this embodiment, the two switches S₁, S₂ may, as schematically represented by the arrows “<<”, be switched by a microprocessor or microcontroller (not represented) or by using a computer program executed on the microprocessor or microcontroller. It is, however, also possible to switch the two switches S₁, S₂ in another way. As represented in more detail in FIG. 2, a switching voltage U_{SW}>0 may be applied to the switch node SW during a first time period, in which the first switch S₁ is set to “ON”. As is furthermore represented in more detail in FIG. 2, on the other hand, the switching voltage at the switch node SW may be U_{SW}=0 during a second time period, in which the second switch S₂ is set to “ON”. In this way, it is possible to adjust a switching period tₚ, which may be given as the sum of the first time period and the second time period. A duty cycle or duty factor D may furthermore be adjusted. As already mentioned above, the duty cycle D is defined in that the time D·tₚ specifies a time interval during which the switching voltage is U_{SW}=0.

In the exemplary embodiments according to FIG. 1, an output voltage U_{Cout} which provides an output current Iₒᵤₜ, which according to the present method is used to control the series resonant converter 110, is assumed in the secondary circuit 114. The output voltage U_{Cout} may in this case, in particular, be given by the load applied to the secondary circuit 114, in which case the output voltage U_{Cout} may be buffered by an output capacitor Cₒᵤₜ (represented by way of example in FIG. 5). In particular for simplified calculation of the series resonant converter 110 represented by way of example in FIG. 1, the output capacitor Cₒᵤₜ has been approximated as a voltage source. Other configurations are, however, possible.

The embodiment according to FIG. 1a shows two secondary windings 120, across which a secondary circuit voltage U_{sec} drops, of the transformer 116, as well as two diodes D₃, D₄ which are used as a secondary rectifier. In the embodiment according to FIG. 1b, conversely, only one secondary winding 120 of the transformer 116, across which the secondary circuit voltage U_{sec} drops, is represented, as well as four diodes D₁, D₂, D₃, D₄, which are used as the secondary rectifier. In the embodiment according to FIG. 1c, the transformer 116 is omitted and the series resonant oscillating circuit 118 is connected directly to the secondary rectifier, which comprises the four diodes D₁, D₂, D₃, D₄. In the embodiment according to FIG. 1d, the full bridge described above is used, to which the series resonant oscillating circuit 118 is connected. As schematically represented, the transformer may be omitted in the embodiment according to FIG. 1d; as an alternative, however, a transformer may be used (not represented).

FIG. 2 shows a schematic representation of a time profile of selected voltages and currents in a preferred embodiment of the proposed method for controlling the series resonant converter 110 over precisely one switching period tₚ, which preferably lies in the range of a few us here. As schematically represented in FIG. 2, the precisely one switching period tₚ in this case comprises the individual time intervals Δt₁, Δt₂, Δt₃ and Δt₄ which are configured following one another in the order specified. In this case, method steps a) to d) are respectively carried out in one of the time intervals Δt₁, Δt₂, Δt₃ and Δt₄, respectively in the order specified. An averaged value over the precisely one switching period tₚ may therefore be specified for the output current Īₒᵤₜ of the secondary circuit 114 according to the following Equation (3):

$${\overline{I}}_{o u t} = \frac{1}{{t}_{p}} ( {\int }_{t = 0}^{t = {t}_{1}} {I}_{n = 1} ( t ) dt + {\int }_{t = {t}_{1}}^{t = {t}_{2}} {I}_{n = 2} ( t - {t}_{1} ) dt + {\int }_{t = {t}_{2}}^{t = {t}_{3}} {I}_{n = 3} ( t - {t}_{2} ) dt + {\int }_{t = {t}_{3}}^{t = {t}_{4}} {I}_{n = 4} ( t - {t}_{3} ) dt ) \qquad ( 3 )$$

As represented in FIG. 2a, during the time intervals Δt₁, Δt₂, i.e. while carrying out method steps a) and b), the switching voltage U_{SW}>0 is applied to the switch node SW; conversely, the switching voltage is U_{SW}=0 at the switch node SW during the time intervals Δt₃, Δt₄, i.e. while carrying out method steps c) and d).

As already mentioned above, the instantaneous output current Iₒᵤₜ of the series resonant converter 110 usually exhibits a sinusoidal profile. In the exemplary embodiment according to FIG. 2, however, the operation of the series resonant converter 110 is carried out at a frequency above the resonant frequency f_{R}, preferably at a frequency above 1.5 times, particularly preferably at double the resonant frequency f_{R}, so that a first Taylor series approximation of the sinusoidal profile may be used.

A capacitor voltage U_{C} applied to the capacitance C₁ of the series resonant oscillating circuit 118 may experience a change as a function of time according to the following Equation (4):

$$\frac{d}{dt} {U}_{C 1} = \frac{{I}_{i}}{{C}_{1}} , \qquad ( 4 )$$

in which the current Iᵢ through the capacitance C₁ is also included. In order to keep the change in the capacitor voltage U_{C} as small as possible, the capacitance C₁ should consequently be selected to be as large as possible.

FIG. 2b shows the time profile of the instantaneous current Iᵢ less the magnetizing current Iₘ through the capacitance C₁. In this case, the values of the current Iₙ during each of the time intervals Δt₁, Δt₂, Δt₃ and Δt₄ may be described by the following Equation (5):

$${I}_{n} ( t ) = {s}_{n} \frac{{U}_{SW , n} - {U}_{C} - {U}_{out , n}}{{L}_{i}} , \qquad ( 5 )$$

where sₙ=+1 applies for the time intervals Δt₁, Δt₂, while sₙ=1 applies for the time intervals Δt₃, Δt₄.

From Equation (5), it may be seen that the values of the current Iₙ for the time intervals Δtₙ, with n=1, 2, 3 or 4, through the capacitance C₁ are determined by the following three voltages: switching voltage U_{SW}, capacitor voltage U_{C} and output voltage Uₒᵤₜ of the primary circuit 112. The time profile of the switching voltage U_{SW} may in this case be taken from the representation in FIG. 2a.

The time profile of each current contribution during each of the time intervals Δt₁, Δt₂, Δt₃ and Δt₄ may therefore respectively be specified according to Equation (6):

$${\int }_{t = 0}^{t = {t}_{n}} {I}_{n} ( t ) dt = {s}_{n} \frac{{U}_{SW , n} - {U}_{C} - {U}_{out , n}}{2 {L}_{i}} {t}_{n}^{2} \qquad ( 6 )$$

For the capacitor voltage U_{C} applied to the capacitance C₁, it may be assumed that this can be described according to the following Equation (7):

U_{C}=(1−D)U_{dc} (7)

By using this equation, the following Equations of time (8) to (11) may be determined:

$$\begin{matrix}{t}_{1} = \frac{( 1 - D ) {U}_{dc} - {U}_{Cout}}{2 {U}_{d c}} {t}_{p} & ( 8 ) \\ {t}_{2} = \frac{( 1 - D ) {U}_{d c} + {U}_{Cout}}{2 {U}_{d c}} {t}_{p} & ( 9 ) \\ {t}_{3} = \frac{D {U}_{d c} - {U}_{Cout}}{2 {U}_{d c}} {t}_{p} & ( 10 ) \\ {t}_{4} = \frac{D {U}_{d c} + {U}_{Cout}}{2 {U}_{d c}} {t}_{p} & ( 11 )\end{matrix}$$

FIG. 2c shows the time profile of the non-rectified output voltage of the transformer Uₒᵤₜ (solid line), which is converted by the downstream secondary rectifier into the output DC voltage U_{Cout} (dashed line).

FIG. 2d in this case shows the time profile of the voltage Uᵢ across the inductance Lᵢ. The time derivative of the voltage Uᵢ across the inductance Lᵢ finally gives the change in the current Iᵢ as a function of time, which is represented in FIG. 2b.

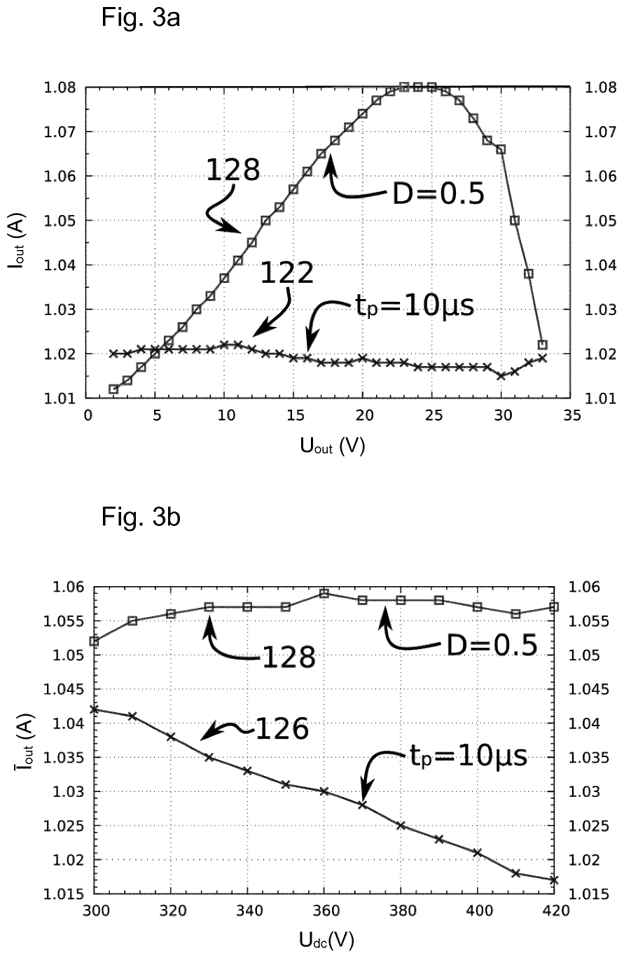

FIG. 3a shows a representation of two measurement curves 122, 124, which were respectively obtained for the averaged output current Īₒᵤₜ as a function of the output voltage Uₒᵤₜ of the primary side 112 of the series resonant converter 110. In this case, in a measurement curve 122, the switching period tₚ=10 μs was set, while the duty cycle D was varied. In contrast thereto, in a measurement curve 124, the duty cycle D=0.5 was set, while the switching period was varied. In the two measurement curves 122, 124, occurrence of an offset current may be seen. The measurement curve 122 in this case depicts the averaged output current Īₒᵤₜ for a fixed switching frequency of 100 kHz, while the measurement curve 124 depicts the averaged output current Īₒᵤₜ in amperes for a duty cycle D of 0.5. While the measurement curve 122 shows an almost constant profile over the considered range of the output voltage Uₒᵤₜ of the primary side 112, a change in the averaged output current Īₒᵤₜ by about 70 mA may be seen in the measurement curve 124.

FIG. 3b shows a representation of two further measurement curves 126, 128 which were respectively obtained for the averaged value of the output current Īₒᵤₜ as a function of the link voltage U_{dc}. In this case, in the measurement curve 126, the switching period tₚ=10 μs was set, while the duty cycle D was varied. In contrast thereto, in the measurement curve 128, the duty cycle D=0.5 was set, while the switching period was varied. In the two further measurement curves 126, 128, occurrence of an offset current may likewise be seen. From the measurement curve 126, it may be seen that the averaged value of the output current Īₒᵤₜ decreases with an increase in the link voltage U_{dc}, a change in the averaged output current Īₒᵤₜ by about 70 mA being visible in FIG. 3b.

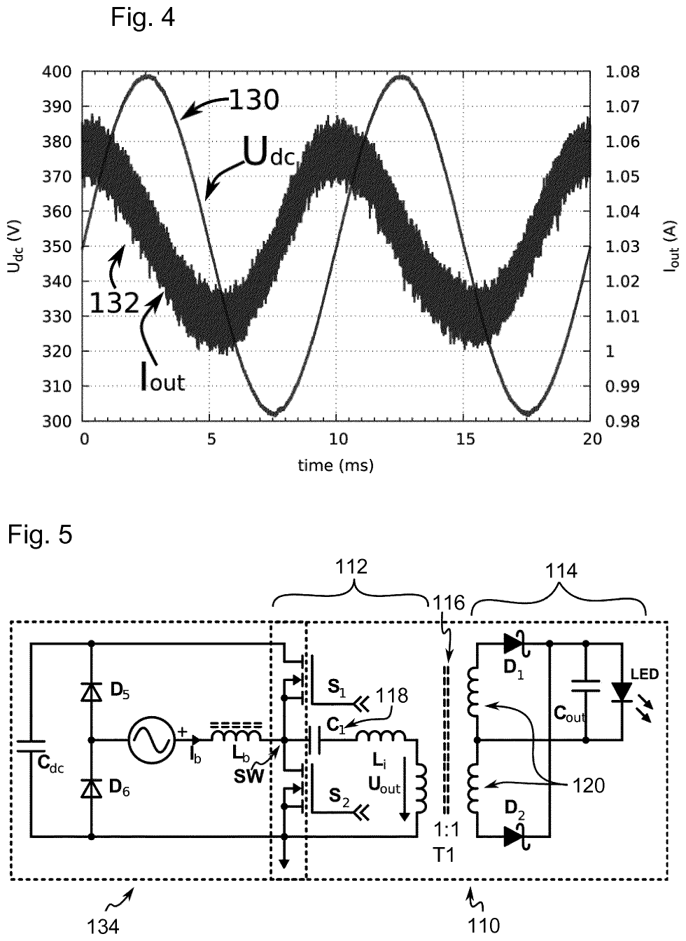

FIG. 4 shows a representation of two further measurement curves 130, 132, the measurement curve 130 depicting the time profile of the link voltage U_{dc} and the measurement curve 132 depicting the time profile of the instantaneous output current Iₒᵤₜ. As may be seen from the measurement curve 130, the link voltage U_{dc} is in this case varied by a value of about 100 V, while the instantaneous output current Iₒᵤₜ changes only by about 6%. Such a small change in the instantaneous output current Iₒᵤₜ with such a high change in the link voltage U_{dc} cannot be achieved with known methods for operating the series resonant converter 110.

FIG. 5 shows a schematic representation of a further preferred embodiment of the series resonant converter 110, which has been supplemented with a circuit 134 for power factor correction (PFC). In this embodiment, the circuit 134 for power factor correction may be added at the switch node SW as an additional converter, which may be modeled in such a way that both the switching period tₚ and the duty cycle D can in this case be used as degrees of freedom. The circuit 134 for power factor correction may in particular be used to generate a quasi-sinusoidal network supply current, while the series resonant converter 110 is configured to convert the link voltage U_{dc} into the output voltage U_{Cout}.

In FIG. 5, the approximation used for simplified calculation of the series resonant converter 110 represented in FIG. 1, i.e. to approximate the output capacitor Cₒᵤₜ as a voltage source, is not carried out. Rather, the output voltage U_{Cout} applied to the output capacitor Cₒᵤₜ in FIG. 5 is used by way of example to drive a light-emitting diode (LED) as a load. Other types of loads are, however, possible.

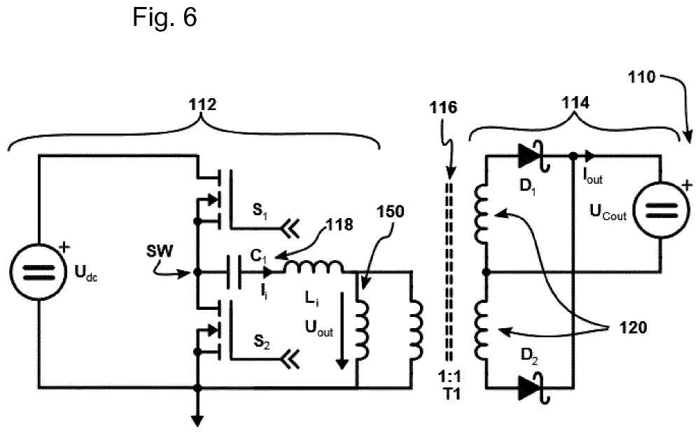

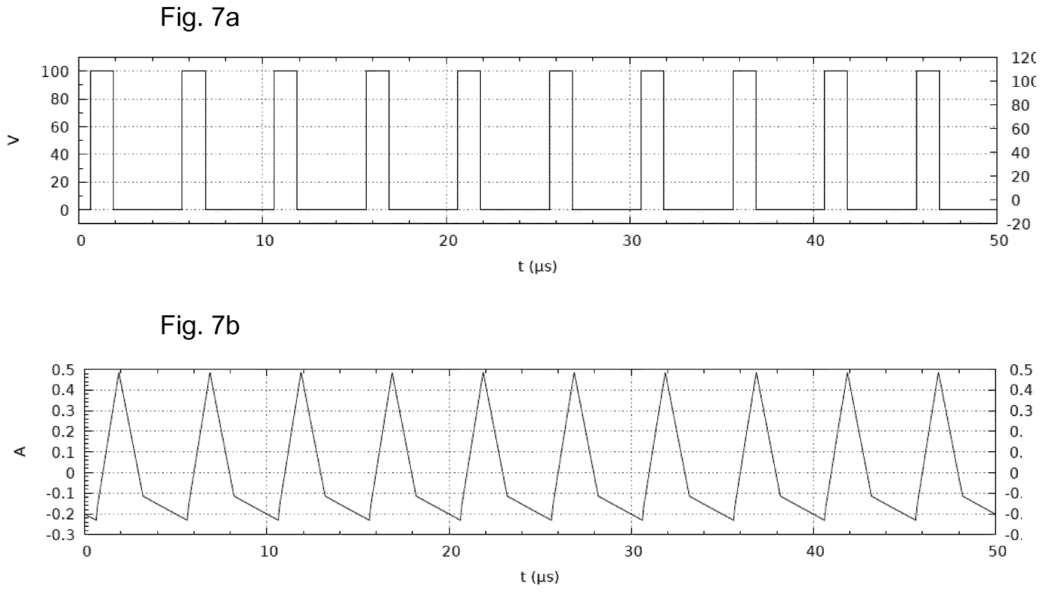

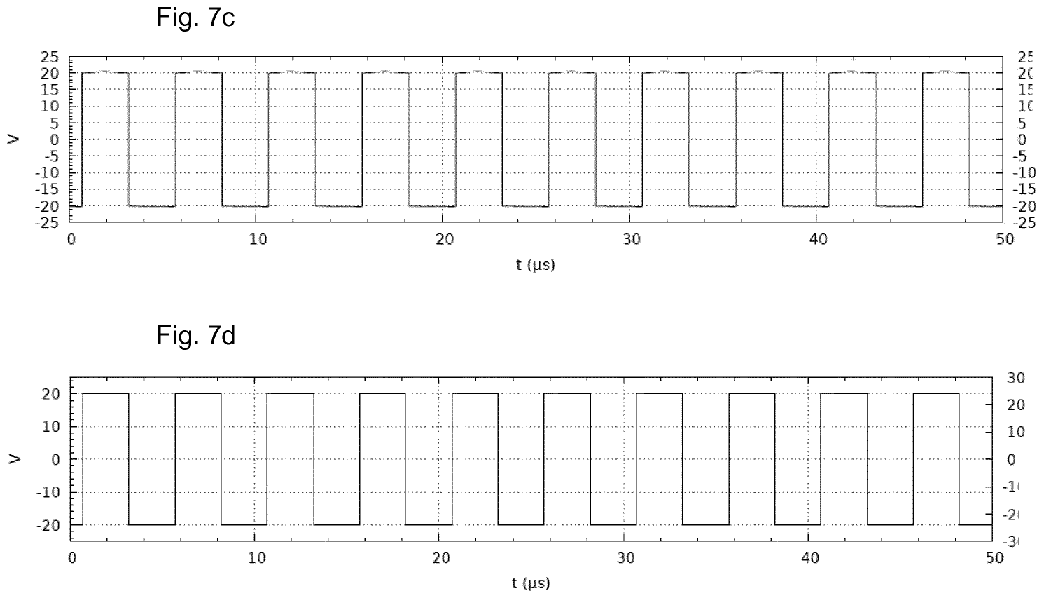

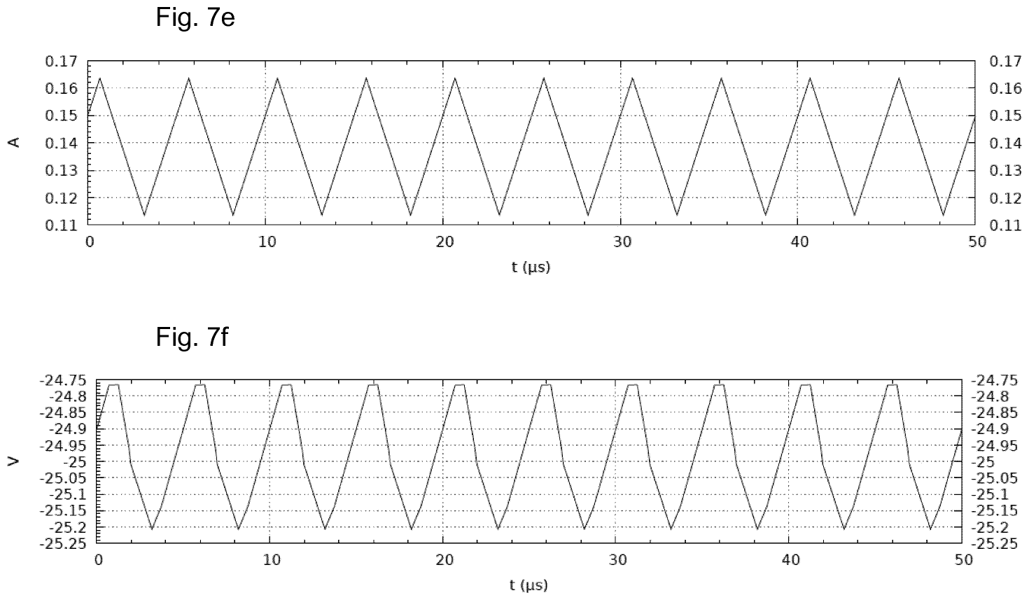

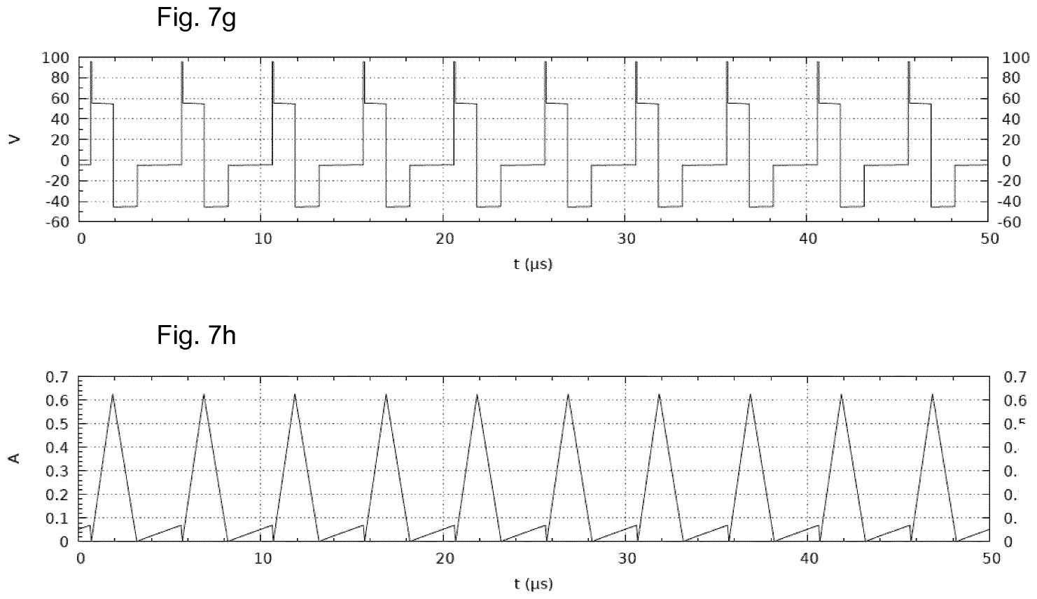

FIG. 6 shows a schematic representation of a circuit which was used to simulate the preferred embodiment of the series resonant converter 110 according to FIG. 1a, an inherent magnetizing inductance 136 of the transformer 116 additionally having been taken into account in the simulation. Curve profiles which were obtained in the simulation by using the circuit according to FIG. 6 are represented in FIG. 7. In the simulation, the primary circuit 112, which comprises the two switches S₁, S₂, is driven by using an asymmetrical duty cycle D. The parameters of the simulation carried out are as follows:
duty cycle D=0.25;
input voltage U_{dc}=100 V;
load voltage: 20 V;
transformer turns ratio 1:1;
switching frequency of the half bridge: 200 kHz;
stray inductance 100 μH; and
magnetizing inductance 1 mH.

FIG. 7a shows a time profile 138 of the voltage of the primary circuit 112 in relation to ground. The time profile 138 of the voltage of the primary circuit 112 represents a square-wave voltage which has 0 V as its minimum value and the link voltage U_{dc} as its maximum value. In the simulation, U_{dc}=100 V was selected as the value of the link voltage. The primary circuit 112 is driven with a low duty cycle D=0.25 in the simulation.

FIG. 7b shows a time profile 140 of the current of the inductance Lᵢ. The time profile 140 of the current of the inductance Lᵢ may be described as triangular. In addition, the current of the inductance Lᵢ is shifted by a magnetizing current due to the magnetizing inductance. This does not however contribute to the output current, and has therefore been neglected in FIG. 2b. Because of the low duty cycle D=0.25, a current with a very high absolute value may occur during the positive period, while a current with a very low absolute value may occur during the negative period. The transformer 116, as is furthermore shown by FIG. 7b, may furthermore have an integrated stray inductance or an external stray inductance.

FIG. 7c shows a time profile 142 of the primary voltage applied to the transformer 116, while a time profile 144 of the secondary voltage applied to the transformer 116 is represented in FIG. 7d. As may be seen from FIGS. 7c and 7d, it was possible to confirm the assumption that the positive amplitude and the negative amplitude of the output voltage U_{Cout} are equal independently of the duty cycle D, since the amplitudes of the output voltage U_{Cout} are respectively given by the secondary rectifier located in the secondary circuit 114.

FIG. 7e shows a time profile 146 of the magnetizing current. As may be seen from FIG. 7d, the voltage-time areas of the inductance Lᵢ and of the transformer 116 according to the simulation are always equally large, in particular since, as represented in FIG. 7e, a main current through the inductance Lᵢ does not diverge. As may be seen from FIG. 7d, the voltage applied to the transformer 116 always has a duty cycle D=0.5, even if, as shown by FIG. 7a, the exciting duty cycle D is highly asymmetrical. The transformer 116 therefore does not saturate at the same output voltage U_{Cout}. Furthermore, the capacitor voltage U_{C} applied to the capacitance C₁, the time profile 148 of which is represented in FIG. 7f, ensures a DC voltage offset so that the transformer 116 is exposed to an alternating current. The transformer 116 may be exposed to no DC current by the capacitance C₁.

The voltages which are applied to the inductance Lᵢ have differing levels, as may be seen from FIG. 7g, in which a time profile 150 of the output voltage U_{Cout} at the transformer 116 is represented. In this case, however, the voltage-time areas are congruent. With an increasing duty cycle D, the voltage difference of the peak values increases. To this end, the voltage for each of the time intervals Δt₁, Δt₂, Δt₃ and Δt₄, from which the coil currents may then be calculated, were observed individually in the simulation. On the basis of the inductance Lᵢ, an averaged value of the output current Īₒᵤₜ was then determined. The value of the inductance Lᵢ is invariant and may therefore be used in Equation (1). As already mentioned, it may be seen from FIG. 7g that the voltage-time areas of the output voltage U_{Cout} at the transformer 116 are equally large. With correct configuration, however, no saturation of the transformer 116 is to be observed, since, as explained above, the voltage applied to the transformer 116 always has a duty cycle D=0.5.

FIG. 7h shows a time profile 152 of the output current of the series resonant converter 110. When the link voltage U_{dc} is applied to the primary circuit 112, a very high output current may be observed. If the primary circuit 112 is at zero volts, however, a very low output current may be observed. It may furthermore be seen from FIG. 7h that the magnetizing current Iₘ on the primary side has no effect on the output current Iₒᵤₜ.

### LIST OF REFERENCE SIGNS

110 series resonant converter
112 primary circuit
114 secondary circuit
116 transformer
118 series resonant oscillating circuit
120 secondary winding
122 to 132 measurement curve
134 circuit for power factor correction
136 inherent magnetizing inductance
138 to 152 time profile

1. A method for controlling a series resonant converter,
wherein the series resonant converter comprises a primary circuit and a secondary circuit,
wherein the primary circuit or the secondary circuit comprises a series resonant oscillating circuit,
wherein the series resonant oscillating circuit comprises at least one capacitance C₁ and at least one inductance Lᵢ,
wherein a link voltage U_{dc} is applied to the primary circuit, and wherein the secondary circuit provides an average output current Īₒᵤₜ,
wherein the control of the series resonant converter is carried out by adjusting an averaged value of the output current Īₒᵤₜ using a transfer function,
wherein the transfer function is a function of the link voltage U_{dc}, the output voltage U_{Cout}, the inductance Lᵢ, a switching period tₚ and a duty cycle D,
wherein at least one of the switching period tₚ or the duty cycle D are adjusted.

2. The method of claim 1, wherein the transfer function is furthermore a function of the at least one capacitance C₁ of the series resonant oscillating circuit.

3. The method of claim 1, wherein the series resonant converter is operated at a frequency above a resonant frequency f_{R},
wherein the resonant frequency is given by the at least one capacitance C₁ and the at least one inductance Lᵢ in the series resonant oscillating circuit.

4. The method of claim 1, wherein the primary circuit and the secondary circuit are DC-isolated from one another by a transformer.

5. The method of claim 1, wherein the transfer function is an analytically soluble function.

6. The method of claim 1, wherein the averaged value of the output current Īₒᵤₜ is determined by using the transfer function
$${\overline{I}}_{out} = \frac{D ( 1 - D ) {U}_{dc}^{2} - {U}_{Cout}^{2}}{4 {L}_{i} {U}_{dc}} \cdot {t}_{p} . \qquad ( 1 )$$

7. The method of claim 1, wherein the duty cycle D is adjusted to from 0.1 to 0.9.

8. The method of claim 1, wherein the switching period tₚ is adjusted to from 0.01 μs to 100 ms.

9. The method of claim 1, wherein the switching period tₚ and the duty cycle D are adjusted independently of one another by actuating switches S₁, S₂ present in the primary circuit.

10. The method of claim 1, wherein the switching period tₚ and the duty cycle D are determined by using a numerical method.

11. The method of claim 1, wherein the primary circuit comprises at least one half bridge, wherein the link voltage U_{dc} or a zero potential is applied to a switch node SW at an instant in the half bridge.

12. The method of claim 1, wherein the primary circuit comprises at least one full bridge, wherein the link voltage U_{dc} or a zero potential is applied at an instant to a first switch node SW1 and to a second switch node SW2 in the full bridge.

13. The method of claim 13, wherein the following steps are carried out within a single switching period tₚ:
a) switching on the half bridge arranged in the primary circuit, so that a current Iᵢ through the inductance Lᵢ increases as a function of time until a zero crossing occurs for the current Iᵢ;
b) increasing the current Iᵢ further as a function of time until the half bridge arranged in the primary circuit of the series resonant oscillating circuit is switched off;
c) decreasing the current Iᵢ as a function of time until a zero crossing occurs for the current Iᵢ; and
d) decreasing the current Iᵢ further as a function of time.

14. The method of claim 11, wherein a circuit for power factor correction is connected to the switch nodes SW.

15. The method of claim 1, wherein the series resonant converter is optimized in respect of a minimal output voltage ripple or a minimal power loss.

16. A computer program which is configured to carry out the method of claim 1.

17. A computer program which is configured to carry out steps of the method of claim 13.

18. The method of claim 6, wherein the duty cycle D is adjusted to from 0.1 to 0.9.

19. The method of claim 6, wherein the switching period tₚ is adjusted to from 0.01 μs to 100 ms.

20. The method of claim 13, wherein a circuit for power factor correction is connected to the switch nodes SW.
